(19) United States
(12) Patent Application Publication
(10) Pub. No.: US 2014/0287262 A1
(43) Pub. Date: Sep. 25, 2014

(54) TIN-PLATED COPPER-ALLOY MATERIAL FOR TERMINAL HAVING EXCELLENT INSERTION/EXTRACTION PERFORMANCE

(71) Applicant: MITSUBISHI MATERIALS CORPORATION, Tokyo (JP)

(72) Inventors: Naoki Kato, Naka-shi (JP); Yuki Inoue, Naka-shi (JP); Yoshie Tarutani, Naka-shi (JP)

(73) Assignee: MITSUBISHI MATERIALS CORPORATION, Tokyo (JP)

(21) Appl. No.: 14/212,014

(22) Filed: Mar. 14, 2014

(30) Foreign Application Priority Data
Mar. 25, 2013 (JP) 2013-062324
Nov. 29, 2013 (JP) 2013-248189

(51) Int. Cl. H01B 1/02

(52) U.S. Cl. CPC H01B 1/026
USPC 428/647

(57) ABSTRACT

Tin-plated copper-alloy terminal material in which Sn-based surface layer is formed on a surface of a substrate made of Cu alloy, and a Cu—Sn alloy layer is formed between the Sn-based surface layer and the substrate; the Cu—Sn alloy layer contains Cu₆Sn₅ as major proportion and has a compound in which a part of Cu in the Cu₆Sn₅ is substituted by Ni and Si in the vicinity of a boundary face at the substrate side; an arithmetic average roughness Ra of the Cu—Sn alloy layer is 0.3 μm or more in at least one direction and an arithmetic average roughness Ra in all direction is 1.0 μm or less; an oil-sump depth Rvk of the Cu—Sn alloy layer is 0.5 μm or more; and an average thickness of the Sn-based surface layer is 0.4 μm or more and 1.0 μm or less and dynamic friction coefficient is 0.3 or less.

### BACKGROUND OF THE INVENTION

1. Field of the Invention

The present invention relates to tin-plated copper-alloy material for terminal that is useful for a terminal for a connector used for connecting electrical wiring of automobiles or personal products, in particular, which is useful for a terminal for a multi-pin connector.

Priority is claimed on Japanese Patent Application No. 2013-62324, filed on Mar. 25, 2013 and Japanese Patent Application No. 2013-248189, filed on Nov. 29, 2013, the content of which is incorporated herein by reference.

2. Background Art

Tin-plated copper-alloy material for terminal is formed by reflowing after Cu-plating and Sn-plating on a substrate made of copper alloy so as to have a Sn-based surface layer as a surface layer and a Cu—Sn alloy layer as a lower layer, and is widely used as material for terminal.

In recent years, for example, electrification is rapidly progressed in vehicle and circuits are increased in the electrical equipment, so that connector used in the circuit is remarkably downsized and the pins thereof are increased. When the connector have a lot of pins, even though a force for inserting the connector for a pin is s all, a large force is required for inserting the connector for all pins; therefore, it is apprehended that productivity is deteriorated. Accordingly, it is attempted to reduce the force for inserting for a pin by reducing a friction coefficient of tin-plated copper-alloy material.

For example, surface roughness of a substrate is predetermined in Japanese Patent No. 4,024,244, and an average of surface roughness of a Cu—Sn alloy layer is predetermined in Japanese Unexamined Patent Application, First Publication No. 2007-63624. However, it is not possible to reduce a dynamic friction coefficient to 0.3 or less.

Productivity may be deteriorated by an increase of insertion force for inserting a connector as the connector is miniaturized and the pins of the connector is increased. The insertion force F is calculated as F=2×μ×P if contact pressure of a female terminal to a male terminal is P and a dynamic friction coefficient is μ because the male terminal is typically inserted between the female terminals vertically. It is effective to reduce P in order to reduce F. However, in order to maintain electrical connection reliability between the male and female terminals when the connectors are fitted, it is not possible to reduce the contact pressure aimlessly. It is necessary to maintain the insertion force F to be about 3 N. In the multi-pin connector, even when a number of the pins for one connector may exceed 50, it is desirable that the insertion force of the connector be 100 N or less, or if possible, 80 N or less, or 70 N or less. Accordingly, the dynamic friction coefficient is necessitated to be 0.3 or less.

### SUMMARY OF THE INVENTION

### Problems to be Solved by the Invention

If thickness of an Sn-based surface layer is reduced so that a harder Cu—Su alloy layer than Sn is exposed at a surface layer, a friction coefficient can be extremely reduced. However, if the Cu—Sn alloy layer is exposed at the surface layer, a Cu-oxide is generated at the surface layer; as a result, contact resistance may be increased and soldering wettability may be deteriorated. Furthermore, it is not possible to reduce a dynamic friction coefficient to 0.3 or less even if grain size and an average of surface roughness of the Cu—Sn alloy layer are controlled.

The present invention is achieved in consideration of the above circumstances, and has an object of reducing a dynamic friction coefficient to 0.3 or less with an excellent electrical-connection characteristic so as to provide tin-plated copper-alloy material for terminal with an excellent insertion/extraction performance.

### Means for Solving the Problem

If surface-exposure of a Cu—Su alloy layer is reduced, thickness of an Sn-based surface layer is necessitated to be formed less than 0.1 μm. However, it may cause deterioration of soldering wettability and increase in contact resistance.

The inventors recognized by earnest research that, with respect to a Cu—Sn alloy layer which is formed by roughening treatment of a surface of a substrate in advance, carrying out Cu-plating and Sn-plating, and then reflowing it, it an be realized to reduce a dynamic friction coefficient to 0.3 or less by: setting an arithmetic average roughness Ra of the Cu—Sn alloy layer in at least one direction to 0.3 μm or more and an arithmetic average roughness Ra of the Cu—Sn alloy layer in all direction to 1.0 μm or less; setting an oil-sump depth Rvk of the Cu—Sn alloy layer to 0.5 μm or more; and setting an average thickness of an Sn-based surface layer to 0.4 μm or more and 1.0 μm or less. Furthermore, it is recognized that existence of Ni and Si is important in order to obtain desired oil-sump depth Rvk. Based on these findings, following solutions are provided. In the above recognition, the inventors found following means for solving the problems.

Namely, a tin-plated copper-alloy material for terminal according to the present invention includes an Sn-based surface layer formed on a surface of a substrate made of Cu alloy, and a Cu—Sn alloy layer formed between the Sn-based surface layer and the substrate; the Cu—Sn alloy layer contains Cu₆Sn₅ as a major proportion and has a compound in which a part of Cu in the Cu₆Sn₅ is substituted by Ni and Si in the vicinity of a boundary face at the substrate side; an arithmetic average roughness Ra of the Cu—Sn alloy layer is 0.3 μm or more in at least one direction and an arithmetic average roughness Ra in all direction is 1.0 μm or less; an oil-sump depth Rvk of the Cu—Sn alloy layer is 0.5 μm or more; and an average thickness of the Sn-based surface layer is 0.4 μm or more and 1.0 μm or less and a dynamic friction coefficient is 0.3 or less.

By increasing the arithmetic average roughness Ra of the Cu—Sn alloy layer and dissolving Ni and Si into Cu—Sn alloy, so that the Cu—Sn alloy layer having large Rvk is formed. Therefore, a depression part of the Cu—Sn alloy layer is covered with Sn at the surface layer, and the Sn-based surface layer is thinly formed by a protrusion part of the rough Cu—Sn alloy layer. As a result, the excellent contact resistance and soldering wettability can be maintained and low the dynamic friction coefficient can be realized.

When the arithmetic average roughness Ra at the surface of the Cu—Sn alloy layer is measured in multiple directions as described below, if a largest value of the arithmetic average roughness Ra is less than 0.3 μm, a thickness of the Sn-based surface layer is thin at the depression part, so that it is not possible to maintain electrical reliability and soldering wettability. However, if the arithmetic average roughness Ra exceeds 1.0 μm in any direction, the Sn-based surface layer is thick at the depression part, so that the friction coefficient is increased.

Furthermore, if the oil-sump depth is less than 0.5 μm, it is not possible to reduce the dynamic friction coefficient to 0.3 or less.

The average thickness of the Sn-based surface layer is 0.4 μm or more and 1.0 μm or less because: if it is less than 0.4 μm, the soldering wettability and the electrical connection reliability may be deteriorated; and if it exceeds 1.0 μm, the dynamic friction coefficient may be increased because a part of the Cu—Sn alloy layer cannot be exposed at the surface layer and the surface layer is occupied only by Sn.

The dynamic friction coefficient at the Sn-based surface layer tends to be increased if a vertical load for measuring the dynamic friction coefficient is small. However, according to the present invention, the dynamic friction coefficient is scarcely varied if the vertical load is reduced, so that effect can be obtained by the present invention even in small terminals.

In the tin-plated copper-alloy material for terminal according to the present invention, it is preferable that the substrate contain: 0.5 mass % or more and 5 mass % or less of Ni; 0.1 mass % or more and 1.5 mass % or less of Si; 5 mass % or less in total of one or more selected from a group consisting of Zn, Sn, Fe and Mg if necessary; and a balance which is composed of Cu and unavoidable impurities.

The substrate is set to contain 0.5 mass % or more and 5 mass % or less of Ni and 0.1 mass % or more and 1.5 mass % or less of Si because: it is necessary that Ni and Si be supplied from the substrate while reflowing and be dissolved in the Cu—Sn alloy layer in order to form the Cu—Sn alloy layer to have the oil-sump depth Rvk to 0.5 μm or more by the reflow treatment. If Ni is less than 0.5 mass % and Si is less than 0.1 mass %, effects of Ni and Si cannot be obtained. If Ni exceeds 5 mass %, cracks may be occurred by a casting process or a hot-rolling process. If Si exceeds 1.5 mass %, electrical conductivity may be deteriorated.

It is desirable to add Zn and Sn for improvement of strength and heat resistance. Fe and Mg are preferably added for improvement of stress-relaxation property; however, if it exceeds 5 mass % in total, it is not preferable because the electrical conductivity is deteriorated.

### Effects of the Invention

According to the present invention, since the dynamic friction coefficient is reduced, the low contact resistance, the excellent soldering wettability and the low insertion/extraction performance can be realized. Moreover, since the dynamic friction coefficient is small even with the low load, it is suitable for small terminals. Particularly, it is advantageous in terminals used for automobiles or electronic elements, at parts in which the low insertion force for connecting, the suitable contact resistance, and the excellent soldering wettability are necessitated.

### BRIEF DESCRIPTION OF THE DRAWINGS

FIG. 1 is a photomicrograph showing a surface-state of tin-plated copper-alloy material for terminal of Example 1.

FIG. 2 is a sectional photomicrograph showing a vicinity of a boundary face between a substrate and a Cu—Sn alloy layer of the tin-plated copper-alloy material for terminal of Example 1.

FIG. 3 is a photomicrograph showing a surface-state of copper-alloy material for terminal of Comparative Example 5.

FIG. 4 is a sectional photomicrograph showing a vicinity of a boundary face between a substrate and a Cu—Sn alloy layer of the copper-alloy material for terminal of Comparative Example 5.

FIG. 5 is a front view schematically showing an apparatus measuring a dynamic friction coefficient of conductive members.

### DESCRIPTION OF THE PREFERRED EMBODIMENTS

An embodiment of tin-plated copper-alloy material for terminal according to the present invention will be explained.

The tin-plated copper-alloy material for terminal of the present embodiment is constructed as: a Sn-based surface layer is formed on a substrate made of Cu alloy; and a Cu—Sn alloy layer is formed between the Sn-based surface layer and the substrate.

The substrate is copper alloy containing Ni and Si such as Cu—Ni—Si based-alloy, Cu—Ni—Si—Zn based-alloy and the like, furthermore 5% or less by mass in total of one or more selected from a group consisting of Zn, Sn, Fe and M &necessary, and a balance which is composed of Cu and unavoidable impurities. Ni and Si are essential components for the reason that Ni and Si are supplied from the substrate in reflowing so that Ni and Si are dissolved in the Cu—Sn alloy layer in order to make an oil-sump depth Rvk of the Cu—Sn alloy layer to 0.5 μm or more by below-mentioned reflow treatment. Appropriate containing amount in the substrate is 0.5% or more and 5% or less by mass for Ni, and 0.1% or more and 1.5% or less by mass for Si. If Ni is contained less than 0.5% by mass, an effect of Ni cannot be obtained, and if Si is contained less than 0.1% by mass, an effect of Si cannot be obtained. If Ni is contained more than 5% by mass, cracking may be occurred when casting or hot-rolling, and if Si is contained mor than 1.5% by mass, conductivity may be deteriorated.

Zn and Sn improve strength and heat resistance. Fe and Mg improve stress-relief property. In a case in which one or more of Zn, Sn, Fe and Mg is added, it is undesirable that the containing amourexceed 5% by mass in total because the electrical conductivity is deteriorated. Especially, it is desirable to contain all of Zn, Sn, Fe and Mg.

The Cu—Sn alloy layer is formed by the reflow treatment after forming a Cu-plating layer and an Sn-plating layer on the substrate as below-mentioned. Most part of the Cu—Sn alloy layer is Cu₆Sn₅. (Cu, Ni, Si)₆Sn₅ alloy in which a part of Cu is substituted by Ni and Si in the substrate is thinly formed in the vicinity of a boundary face between the Cu—Sn alloy layer and the substrate. The boundary face between the Cu—Sn alloy layer and the Sn-based surface layer is formed unevenly, so that an arithmetic average roughness Ra of the Cu—Sn alloy layer in one direction is 0.3 μm or more, an arithmetic average roughness Ra of Cu—Sn alloy layer in all direction is 10 μm or less, and an oil-sump depth Rvk of the Cu—Sn alloy layer is 0.5 μm or more.

The arithmetic average roughness Ra is measured based on JIS (Japanese Industrial Standards) B0601. Arithmetic average roughnesses of the surface of Cu—Sn alloy layer are measured not only in one direction but also in plural directions including a direction parallel to a rolling direction and a direction orthogonal to the rolling direction. An arithmetic average roughness in at least one direction is 0.3 μm or more and an arithmetic average roughness in all direction is 1.0 μm or less. In general, an arithmetic average roughness Ra in a direction orthogonal to a rolling direction is greater than an arithmetic average roughness Ra in a direction parallel to the rolling direction. If the arithmetic average roughness Ra in any one direction is 0.3 μm, the effect of reducing the dynamic friction coefficient is shown. Therefore the arithmetic average roughness Ra is measured in plural directions. However, if the arithmetic average roughness Ra exceeds 1.0 μm, the Sn-based surface layer is thick at the depression part, so that the friction coefficient increased.

The oil-sump depth Rvk is an average depth of prominent troughs in a surface roughness curve regulated by JIS B0671-2, which is an index indicating an extent of deeper parts than average unevenness. If the value is large, it is indicated that the unevenness is steep by existence of very deep trough.

An average thickness of the Sn-based surface layer is not less than 0.4 μm and not more than 1.0 μm. If the thickness is less than 0.4 μm, soldering wettability and electrical-connection reliability may be deteriorated; and if it exceeds 1.0 μm, a surface layer cannot be composite construction of Sn and Cu—Sn alloy and may be filled only by Sn, so that the dynamic friction coefficient is increased.

In the material for terminal having such composition, the boundary face between the Cu—Sn alloy layer and the Sn-based surface layer is formed to have steep uneven shape, so that: soft Sn exists in the steep troughs of the hard Cu—Sn alloy layer in a depth range of hundreds urn from the surface of the Sn-based surface layer, and a part of the hard Cu—Sn alloy layer is slightly exposed at the Sn-based surface layer at the surface; the soft So existing in the troughs acts as lubricant; and the dynamic friction coefficient is 0.3 or less.

Next, a method for producing the material for terminal will be explained.

A plate made of copper alloy such as Cu—Ni—Si based-alloy, Cu—Ni—Si—Zn based-alloy or the like containing Ni and Si, furthermore 5% or less by mass in total of one or more selected from a group consisting of Zn, Sn, Fe and Mg if necessary, and a balance which is composed of Cu and unavoidable impurities is prepared for a substrate. The surface of the plate is roughened, by the method of chemical etching, electrolytic polishing, rolling by a roll having a roughened surface, polishing, shot blasting or the like. As a degree of the roughness, the desirable arithmetic average roughness Ra is 0.3 μm or more and 2 μm or less. Thereafter, surfaces of the plate are cleaned by treatments of degreasing, pickling and the like, the Cu-plating and Sn-plating are operated in sequence.

In Cu-plating, an ordinary Cu-plating bath can be used; for example, a copper-sulfate plating bath or the like containing copper sulfate (CuSO₄) and sulfuric acid (H₂SO₄) as major ingredients can be used. Temperature of the plating bath is set to 20° C. or more to 50° C. or less; and current density set to 1 A/dm² or more to 20 A/dm² or less. A film thickness of a Cu-plated layer which is fumed by the Cu plating is set to 0.03 μm or more and 0.15 μm or less. If it is less than 0.03 μm, the alloy substrate has a significant influence, so that the Cu—Sn alloy layer grows to the surface layer, glossiness and the soldering wettability are deteriorated; or if it exceeds 0.15 μm, Ni and Si cannot be supplied enough from the substrate while reflowing, so that the desired uneven shape of the Cu—Sn alloy layer cannot be made.

As a plating bath for making the Sn-plating layer, an ordinary Sn-plating bath can be used; for example, a sulfate bath containing sulfuric acid (H₂SO₄) and stannous sulfate (SnSO₄) as major ingredients can be used. Temperature of the plating bath is set to 15° C. or more to 35° C. or less; and current density is set to 1 A/dm² or more to 30 A/dm² or less. A film thickness of the Sn-plating layer is set to 0.8 μm or more and 2.0 μm or less. If the thickness of the Sn-plating layer is less than 0.8 μm, the Sn-based surface layer is thin after reflowing, so that the electrical-connection characteristic is deteriorated; or if it exceeds 2.0 μm, the exposure of the Cu—Sn alloy layer at the surface is reduced, so that it is difficult to suppress the dynamic friction coefficient to 0.3 or less.

As the condition for the reflow treatment, the substrate is heated in a state in which a surface temperature is not less than 240° C. and not more than 360° C. for not less than 1 second and not more than 12 seconds in a reduction atmosphere, and then the substrate is rapidly cooled. More preferably, the substrate is heated in a state in which the surface temperature is not less than 250° C. and not more than 300° C. for not less than 1 seconds and not more than 10 seconds, and then the substrate is rapidly cooled. In this case, a holding tends to be short when the plating thickness is small, and to be long when the plating thickness is large.

### EXAMPLES

The substrate was a plate of copper alloy (Ni; 0.5% or more and 5.0% or less by mass-Zn; 1.0%-Sn; 0% or more and 0.5% or less by mass-Si; 0.1% or more and 1.5% or less by mass-Fe; 0% or more and 0.03% or less by mass-Mg; 0.005% by mass) having a plate thickness of 0.25 mm, after polishing and roughening of the surface of the substrate, and Cu-plating and Sn-plating were performed in sequence. In this case, plating conditions of the Cu-plating and the Sn-plating were as shown in Table 1. In Table 1, Dk is an abbreviation for current density for a cathode; and ASD is an abbreviation for A/dm².

TABLE 1

| | Cu PLATING | | Sn PLATING | |
|---|---|---|---|---|
| COMPOSITION | COPPER | 250 g/L | TIN | 75 g/L |
| OF PLATING | SULFATE | | SULFATE | |
| SOLUTION | SULFURIC | 50 g/L | SULFURIC | 85 g/L |
| | ACID | | ACID | |
| | | | ADDITIVE | 10 g/L |

| | | |
|---|---|---|
| SOLUTION | 25° C. | 20° C. |
| TEMPERATURE | | |
| Dk | 5 ASD | 5 ASD |

After plating at the thickness shown in Table 2, in Examples and Comparative Examples, the surface temperature of the substrates were held in the reduction atmosphere as reflow treatments in which the surface temperature of the substrates were in a prescribed range of temperature and a prescribed holding time, and then the substrates were cooled by water.

As the Comparative Examples, the substrates in which the plate thicknesses of Cu and Sn were varied so that the film thickness of the Sn-based surface layer was out of the prescribed range were prepared.

The conditions of those test pieces were shown in Table 2.

TABLE 2

| | | | | AVERAGE | THICK- | THICK- | |
|---|---|---|---|---|---|---|---|
| | | | ROUGH- | ROUGH- | NESS | NESS | |
| | | | ENING | NESS | OF Sn- | OF Cu- | |
| | | | TREAT- | Ra OF | PLAT- | PLAT- | |
| | | | MENT OF | SUBSTRATE | ING | ING | REFLOW |
| | | COMPOSITION OF SUBSTRATE | SUBSTRATE | (μm) | (μm) | (μm) | CONDITION |
| EXAM- | 1 | Ni2.0—Zn1.0—Sn0.5—Si0.5—Fe0.03—Mg0.005 wt % | DONE | 0.92 | 1.0 | 0.05 | 270° C. × 6 sec |
| PLES | 2 | Ni2.0—Zn1.0—Sn0.5—Si0.5—Fe0.03—Mg0.005 wt % | DONE | 0.92 | 1.5 | 0.05 | 270° C. × 9 sec |
| | 3 | Ni2.0—Zn1.0—Sn0.5—Si0.5—Fe0.03—Mg0.005 wt % | DONE | 0.92 | 2.0 | 0.05 | 360° C. × 9 sec |
| | 4 | Ni0.5—Zn1.0—Sn0.5—Si0.1—Fe0.03—Mg0.005 wt % | DONE | 0.92 | 1.0 | 0.03 | 270° C. × 6 sec |
| | 5 | Ni5.0—Zn1.0—Sn0.5—Si0.5—Fe0.03—Mg0.005 wt % | DONE | 0.92 | 0.8 | 0.15 | 270° C. × 6 sec |
| COMPAR- | 1 | Ni2.0—Zn1.0—Sn0.5—Si0.5—Fe0.03—Mg0.005 wt % | DONE | 0.92 | 0.7 | 0.05 | 270° C. × 3 sec |
| ATIVE | 2 | Ni2.0—Zn1.0—Sn0.5—Si0.5—Fe0.03—Mg0.005 wt % | DONE | 0.92 | 1.0 | 0.2 | 270° C. × 6 sec |
| EXAM- | 3 | Ni2.0—Zn1.0—Sn0.5—Si0.5—Fe0.03—Mg0.005 wt % | DONE | 0.92 | 2.5 | 0.05 | 270° C. × 12 sec |
| PLES | 4 | Ni2.0—Zn1.0—Sn0.5—Si0.5—Fe0.03—Mg0.005 wt % | DONE | 3.2 | 1.5 | 0.05 | 270° C. × 6 sec |
| | 5 | Ni2.0—Zn1.0—Sn0.5—Si0.5—Fe0.03—Mg0.005 wt % | NO | 0.18 | 1.0 | 0.2 | 270° C. × 6 sec |
| | 6 | Ni2.0—Zn1.0—Sn0.5—Si0.5—Fe0.03—Mg0.005 wt % | NO | 0.18 | 1.5 | 0.05 | 270° C. × 6 sec |
| | 7 | Ni2.0—Zn1.0—Sn0.5—Si0.5—Fe0.03—Mg0.005 wt % | DONE | 0.92 | 0.8 | 0 | 270° C. × 3 sec |
| | 8 | Ni0.3—Zn1.0—Sn0.5—Si0.5—Fe0.03—Mg0.005 wt % | DONE | 0.92 | 1.0 | 0.05 | 270° C. × 6 sec |

With respect to those samples, the thickness of Sn-based surface layer, the arithmetic average roughness Ra of Cu—Sn alloy layer, the oil-sump depth Rvk of the Cu—Sn alloy layer were measured after reflowing, and the dynamic friction coefficient, the soldering wettability, glossiness, and the electrical-connection reliability were evaluated.

The thicknesses of the Sn-based surface layer after reflowing were measured by an X-ray fluorescent analysis thickness meter (SFT9400) by SII Nanotechnology Inc. At first, all the thicknesses of the Sn-based surface layers of the samples after reflowing were measured, and then the Sn-based surface layers were removed by soaking for a few minutes in etchant for abrasion of the plate coatings made from components which do not corrode Cu—Sn alloy but etch pure Sn, for example, by L80 or the like by Laybold Co., Ltd. so that the lower Cu—Sn alloy layers were exposed. Then, the thicknesses of the Cu—Sn alloy layers in pure Sn conversion were measured. Finally, (the thicknesses of all the Sn-based surface layers minus the thickness of the Cu—Sn alloy layer in pure Sn conversion) was defined as the thickness of the Sn-based surface layer.

The arithmetic average roughness Ra and the oil-sump depth Rvk of the Cu—Sn alloy layer were obtained by: removing the Sn-based surface layer by soaking in etchant for abrasion of the Sn-plate coating so that the lower Cu—Sn alloy layer was exposed; and then obtaining from an average of measured Rvk value measured at 5 points in a condition of an object lens of 150 magnifications (a measuring field of 94 μm×70 μm) using a laser microscope (VK-9700) made by Keyence Corporation. The average 1 of surface roughness and the oil-sump depth were measured in a right-angle direction to the direction of polishing at roughening treatment. The average roughness is the greatest in the right-angle direction to the direction of polishing. The average 2 of surface roughness the value measured in a direction parallel to the direction of polishing.

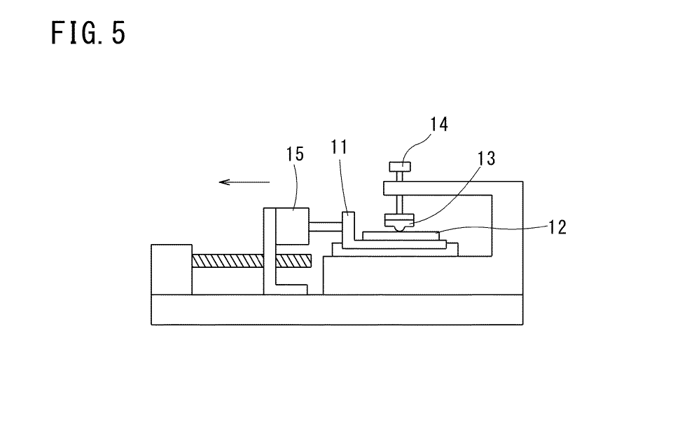

When obtaining the dynamic friction coefficient, in order to simulate a contact portion between a male terminal and a female terminal of a engagement-type connector, a plate-like male test piece and a hemispherical female test piece having a internal diameter of 1.5 mm were prepared for each of the samples. Then, using a device for measuring friction (μV1000, manufactured by Trinity Lab INC.), friction force between the test pieces was measured and the dynamic friction coefficient was obtained. It is explained with reference to FIG. 5 that: the male test piece 12 was fixed on a horizontal table 11, a half-spherical convex of the female test piece 13 was deposited on the male test piece 12 so that plated surfaces were in contact with each other, and the male test piece 12 was pressed at a load P of 100 gf or more to 500 gf or less by the female test piece 13 with a weight 14. In a state in which the load P was applied, a friction force F when the male specimen 12 was extended by 10 mm in a horizontal direction shown by an arrow at a sliding rate of 80 mm/minute was measured through a load cell 15. The coefficients of kinetic friction(=Fav/P) was obtained from the average value Fav of the friction forces F and the load P.

When obtaining the wettability of the soldering, the test pieces were cut with a width of 10 mm, and zero crossing time were measured by the meniscograph method using a rosin-type active flux. (The test pieces were soaked in Sn-37% Pb solder with temperature of the soldering bath of 230° C., soaking rate of 2 mm/sec, soaking depth of 2 mm, and soaking time of 10 sec.) If the solder zero crossing time is not greater than 3 seconds, it was estimated at “good”. If the solder zero crossing time is more than 3 seconds, it was estimated at “poor”.

The glossiness was measured using a gloss meter (model number: PG-1M) made by Nippon Denshoku Industries Co., Ltd. with an entry angle of 60° in accordance with JIS Z 8741.

In order to estimate the electrical reliability, the test pieces were heated in the atmosphere, 150° C.×500 hours, and the contact resistance was measured. The measuring method was in accordance with JIS-C-5402, while a load was changed from 0 to 50 g in sliding type (1 mm) by using a four-terminal contact-resistance test equipment (made by Yamasaki-Seiki Co., Ltd.: CRS-113-AU), relationship between the load and contact resistance was measured, so that a contact resistance value was evaluated when the load was 50 g.

These measurement results and estimate results are shown in Table 3.

TABLE 3

| | | | | | | DYNAMIC | DYNAMIC | | | |
|---|---|---|---|---|---|---|---|---|---|---|
| | | Sn LAYER | | | | FRICTION | FRICTION | | | |
| | | THICKNESS | AVERAGE | AVERAGE | | COEFFI- | COEFFI- | SOLDER- | | CONTACT |
| | | (μm) | ROUGH- | ROUGH- | OIL-SUMP | CIENT | CIENT | ING | GLOSSI- | RESIS- |
| | | AFTER | NESS 1 | NESS 2 | DEPTH | LOAD | LOAD | WETTA- | NESS | TANCE |
| | | REFLOWING | Ra (μm) | Ra (μm) | Rvk (μm) | 500 gl | 100 gl | BILITY | (×10² GU) | (mΩ) |
| EXAM- | 1 | 0.48 | 0.87 | 0.45 | 1.48 | 0.20 | 0.21 | GOOD | 7.1 | 5.31 |
| PLES | 2 | 0.88 | 0.53 | 0.32 | 0.78 | 0.23 | 0.25 | GOOD | 7.8 | 2.51 |
| | 3 | 0.97 | 0.39 | 0.23 | 0.58 | 0.25 | 0.29 | GOOD | 8.2 | 2.21 |
| | 4 | 0.51 | 0.83 | 0.41 | 1.42 | 0.21 | 0.23 | GOOD | 7.2 | 4.93 |
| | 5 | 0.42 | 0.85 | 0.44 | 0.85 | 0.22 | 0.25 | GOOD | 7.1 | 5.94 |
| COMPAR- | 1 | 0.28 | 0.89 | 0.48 | 1.55 | 0.22 | 0.24 | POOR | 5.7 | 11.27 |
| ATIVE | 2 | 0.55 | 0.72 | 0.39 | 0.39 | 0.31 | 0.35 | GOOD | 7.1 | 4.87 |
| EXAMP- | 3 | 1.33 | 0.27 | 0.23 | 0.36 | 0.45 | 0.52 | GOOD | 8.1 | 2.03 |
| LES | 4 | 0.91 | 1.54 | 0.73 | 0.67 | 0.35 | 0.43 | GOOD | 7.9 | 2.44 |
| | 5 | 0.58 | 0.20 | 0.17 | 0.18 | 0.38 | 0.45 | GOOD | 8.5 | 3.02 |
| | 6 | 0.93 | 0.22 | 0.21 | 0.28 | 0.32 | 0.37 | GOOD | 8.7 | 2.36 |
| | 7 | 0.32 | 0.92 | 0.49 | 1.59 | 0.21 | 0.24 | POOR | 5.6 | 13.64 |
| | 8 | 0.58 | 0.69 | 0.35 | 0.35 | 0.33 | 0.39 | GOOD | 7.3 | 4.38 |

Obviously from Table 3, in every Example, the dynamic friction coefficient was small as 0.3 or less, the soldering wettability was good, the glossiness was high, the exterior appearance was good and the contact resistance was 10 mΩ or less.

In contrast, the following problems were observed each comparative example.

In Comparative Example 1, the soldering wettability was poor and the contact resistance was large, because the thickness of Sn-based surface layer was too thin. The friction coefficient of Comparative Example 2 was large, because the oil-sump depth Rvk of the Cu—Sn alloy layer was small. The friction coefficient of Comparative Example 3 was large, because the Sn-based surface layer was too thick. In Comparative Example 4, as a result of the strong roughening of the surface of the substrate, the arithmetic average roughness Ra of Cu—Sn alloy layer after reflowing was more than 1 μm, the Sn-based surface layer was thick at the depression part, so that the friction coefficient was large. In Comparative Example 5 and 6, the arithmetic average roughness Ra and the oil-sump depth Rvk were small, because the roughening treatment of the substrate was not performed, so that the dynamic friction coefficient were large. In Comparative Example 7, as a result of omitting the Cu plating, the influence by the alloy content of the substrate was large, so that the Cu—Sn alloy layer grew to the surface layer and the soldering wettability was poor. In Comparative Example 8, the oil-sump depth Rvk of the Cu—Sn alloy layer was small, because the content of Ni and Si in the substrate were low, so that the dynamic friction coefficient was large.

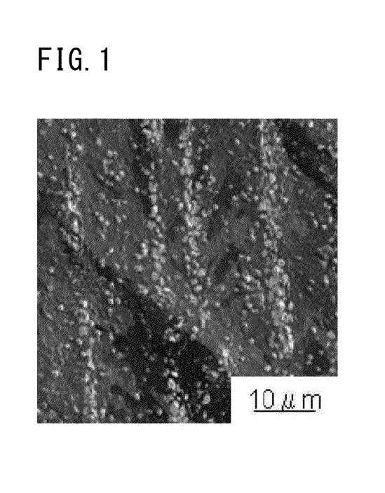

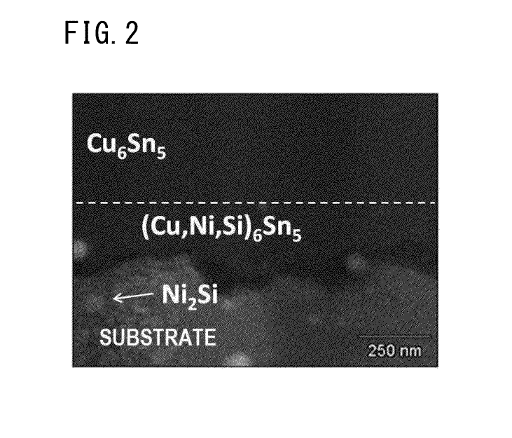

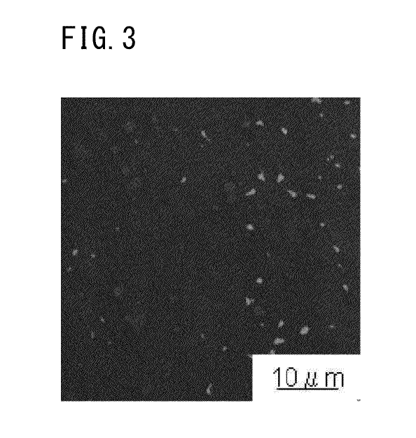

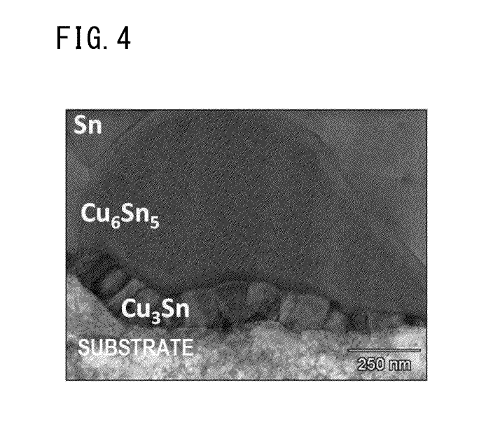

FIG. 1 and FIG. 2 are photomicrographs of the test piece of Example 1 which was observed by a TEM-EDS showing a boundary face between the substrate and the Cu—Sn alloy layer. FIG. 3 and FIG. 4 are photomicrographs like FIG.1 and FIG. 2 of Comparative Example 5. As recognized by comparing those photographs, in the samples of Examples, the Cu—Sn alloy layer is reasonably exposed at a surface of the Sn-based surface layer, (Cu, Ni, Si)₆Sn₅ which is a compound in which a part of Cu was substituted by Ni and Si was slightly found in the vicinity of the boundary face of the Cu—Sn alloy layer at the substrate side (below the broken line in FIG. 2). The samples of the Comparative Examples, as shown in FIG. 4, have constitution in which: a relatively thick Cu₃Sn layer was found at a lower part of the Cu—Sn alloy layer; the Cu₆Sn₅ layer was laminated on the Cu₃Sn layer; and the exposure at the surface was small.

### Description of the Reference Symbols

11 table
12 male test piece
13 female test piece
14 weight
15 load cell

What is claimed is:

1. A tin-plated copper-alloy material for terminal comprising an Sn-based surface layer formed on a surface of a substrate made of Cu alloy, and a Cu—Sn alloy layer formed between the Sn-based surface layer and the substrate, wherein:
the Cu—Sn alloy layer contains Cu₆Sn₅ as a major proportion and has a compound in which a part of Cu in the Cu₆Sn₅ is substituted by Ni and Si in the vicinity of a boundary face at the substrate side;
an arithmetic average roughness Ra of the Cu—Sn alloy layer is 0.3 μm or more in at least one direction and an arithmetic average roughness Ra in all direction is 1.0 μm or less;
an oil-sump depth Rvk of the Cu—Sn alloy layer is 0.5 μm or more; and
an average thickness of the Sn-based surface layer is 0.4 μm or more and 1.0 μm or less and dynamic friction coefficient is 0.3 or less.

2. The tin-plated copper-alloy material for terminal according to claim 1, wherein the substrate contains:
0.5 mass % or more and 5 mass % or less of Ni;
0.1 mass % or more and 1.5 mass % of Si;
5 mass % or less in total of one or more selected from a group consisting of Zn, Sn, Fe and Mg if necessary; and
a balance which is composed of Cu and unavoidable impurities.
